(19) United States
(12) Patent Application Publication
(10) Pub. No.: US 2025/0017821 A1
(43) Pub. Date: Jan. 16, 2025

(54) BAG FITMENT HAVING INTERNAL SPIKE PORT

(71) Applicant: ENTEGRIS, INC., Billerica, MA (US)

(72) Inventors: Robert M. Shydo, JR., Hampstead, NH (US); Marc Kuo, Woodhaven, NY (US)

(21) Appl. No.: 18/740,426

(22) Filed: Jun. 11, 2024

Related U.S. Application Data
(60) Provisional application No. 63/526,910, filed on Jul. 14, 2023.

(51) Int. Cl. A61J 1/14; A61J 1/10

(52) U.S. Cl. CPC A61J 1/1475; A61J 1/10

(57) ABSTRACT

A fitment for forming a bag is provided with an internal spike port aperture, configured to receive a spike. The fitment further includes one or more features to prevent the spike from contacting the bag when the spike is received in the spike port. A bag can be formed by attaching one or more sheets to the fitment. The bag can be interfaced with by inserting the spike through an optional first puncture barrier, into the internal spike port aperture, and through a second puncture barrier disposed in the internal spike port aperture. The internal spike port aperture can be provided on a surface of the fitment such that it does not extend beyond an outer end of the fitment.

### FIELD

This disclosure is directed to fitments having an internal spike port for use in forming bags, and bags formed using such fitments.

### BACKGROUND

Medical bags can include boat ports welded directly to sheets used to form the bag to provide fluid transfer from the bag. Cell and gene therapy bags typically use traditional medical bags and the corresponding fluid transfer methods, for example for administration in clinical settings.

### SUMMARY

This disclosure is directed to fitments having an internal spike port for use in forming bags, and bags formed using such fitments.

By providing a spike port internal to the fitment, a spike port can be provided to facilitate transfer of fluid into and out of the bag. The spike port, when provided internally, can further provide improved resistance to breakage, leaking, and other such issues when the bag is frozen and subsequently thawed. Additionally, the spike port can be configured such that the length of the bag is not increased and no rigid protrusion is required to provide the spike port, allowing the bag to be handled more easily and used with storage and/or transportation equipment without further modification. Features can be provided on the fitment that prevent the spike from contacting and damaging sheets used to form the bag.

In an embodiment, a fitment for a bag includes a fitment body including first and second side walls. Each of the first and second side walls extend between opposing end points. The fitment body includes a biocompatible material. The fitment body includes a spike port aperture and one or more guide features, the guide features configured to separate a spike inserted into the spike port aperture from a bag sheet attached to one or both of the first and second side walls.

In an embodiment, the one or more guide features include a guide projection extending from the fitment body, wherein the spike port aperture extends through the guide projection.

In an embodiment, the one or more guide features include a plurality of wings extending from the first and/or second side walls.

In an embodiment, the fitment further includes a plurality of additional ports formed integrally in the fitment body. In an embodiment, the spike port aperture is located between two of the plurality of additional ports.

In an embodiment, the spike port aperture includes a barrier membrane. In an embodiment, the barrier membrane is formed integrally with the fitment body. In an embodiment, the fitment further includes a barrier film located at an end of the spike port aperture.

In an embodiment, the fitment further includes an internal gasket disposed in the spike port aperture. In an embodiment, the fitment further includes a barrier film located at an end of the spike port aperture.

In an embodiment, a bag includes a fitment. The fitment includes a fitment body including first and second side walls. Each of the first and second side walls extend between opposing end points. The fitment body includes a biocompatible material. The fitment body includes a spike port aperture and one or more guide features, the guide features configured to separate a spike inserted into the spike port aperture from a bag sheet attached to one or both of the first and second side walls. The bag further includes one or more polymer sheets, the one or more polymer sheets joined to the first and second side walls. The one or more polymer sheets are sealed to form the bag. The one or more guide features extend into an internal space defined by the fitment and the one or more polymer sheets. The one or more guide features configured to separate a spike inserted into the spike port aperture from the one or more polymer sheets.

In an embodiment, the one or more guide features include a guide projection extending from the fitment body, wherein the spike port aperture extends through the guide projection.

In an embodiment, the one or more guide features include a plurality of wings extending from the first and/or second side walls.

In an embodiment, the spike port aperture includes a barrier membrane formed integrally with the fitment.

In an embodiment, the bag further includes an internal gasket disposed in the spike port aperture.

In an embodiment, a method of inserting a spike into a bag includes directing the spike into a spike port aperture provided on a fitment included in the bag and driving the spike through a puncture barrier disposed in the spike port aperture, wherein one or more guide features are disposed between the spike and one or more sheets forming the bag once the spike has been inserted into the bag.

In an embodiment, the one or more guide features include a guide projection extending from the fitment body, wherein the spike port aperture extends through the guide projection.

In an embodiment, the one or more guide features include a plurality of wings extending from first and/or second side walls of the fitment.

In an embodiment, the method further includes driving the spike through a second puncture barrier provided on the fitment. In an embodiment, the spike is driven through the second puncture barrier as the spike enters the spike port aperture.

### DRAWINGS

FIG. 1 shows a fitment according to an embodiment.

FIG. 2 shows a sectional view of a fitment according to an embodiment.

FIG. 3 shows a sectional view of a fitment according to an embodiment.

FIG. 4 shows a bag according to an embodiment.

FIG. 5 shows a fitment according to an embodiment.

FIG. 6 shows a sectional view of a fitment according to an embodiment.

FIG. 7 shows a sectional view of a fitment according to an embodiment.

FIG. 8 shows a bag according to an embodiment.

FIG. 9 is a flowchart of a method of interfacing with a bag.

### DETAILED DESCRIPTION

This disclosure is directed to fitments having an internal spike port for use in forming bags, and bags formed using such fitments.

As used herein, a “biocompatible” material refers to a material capable of contacting drug products, proteins, blood products, and/or buffer materials such as buffers used in vaccine manufacture without adverse effects on said drug products, proteins, blood products, and/or buffer materials. Non-limiting examples of biocompatible materials include fluoropolymers, polyolefins such as polyethylene, ethyl vinyl acetate (EVA) polymers, and the like. Biocompatible materials can include laminated materials, for example laminated polyethylene.

As used herein, a “spike” refers to a spike interface for accessing contents of a bag. The spike can be any suitable spike for accessing the contents of the bag. The spike can be part of a bag interface device including tubing, a connection to another device, such as another connector at an opposite end of the tubing from the spike, such as a luer connector, hose barbs, a removable cap, or the like, and/or any other suitable features such as valves, filters, or the like. The spike can have a circular cross-sectional shape. The spike can have an outer diameter in a range from 0.1 inches to 0.5 inches (2.5 millimeters (mm) to 12.7 mm). In embodiments, the size of spikes that are selected for use with a bag can be sizes suitable for the fitment used with said bag.

As used herein, “spike port aperture” is an opening that is configured to accept a spike, such that the spike can be inserted into the bag through the spike port aperture and used to provide fluid communication. The spike port aperture has an internal diameter larger than an outer diameter of the spike to be used in the spike port aperture.

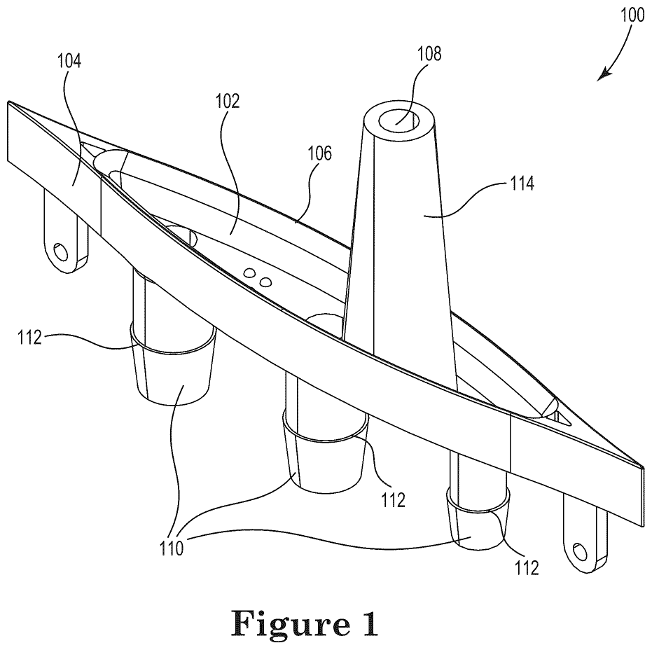

FIG. 1 shows a fitment according to an embodiment. Fitment 100 includes fitment body 102 having first side wall 104 and second side wall 106. Fitment body 102 further includes spike port aperture 108 and one or more additional ports 110 provided on hose barb connections 112. Fitment 100 further includes a guide projection 114.

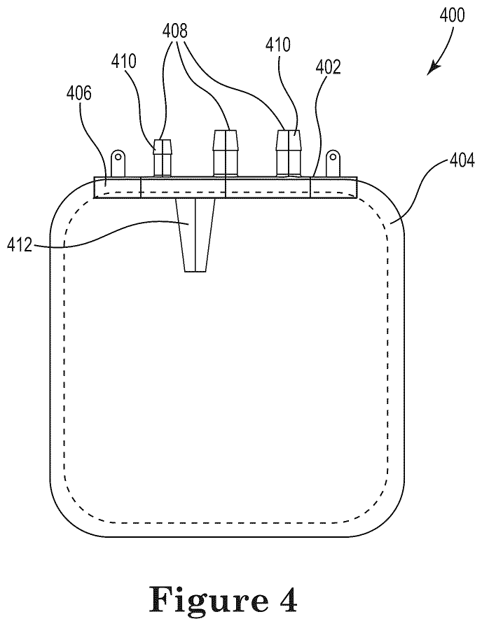

Fitment 100 is a fitment used for forming a bag. One or more sheets can be attached to fitment 100 to define the bag, with the sheets being sealed to the fitment 100 and sealed around a perimeter of the bag outside of the fitment 100, so as to define an internal space. A bag formed using a fitment such as fitment 100 is described below and shown in FIG. 4.

Fitment body 102 is a body configured to form a fitment for a bag. Fitment body 102 can be formed of any suitable biocompatible material, such as a fluoropolymer, a polyolefin, EVA, or the like. In an embodiment, the fitment body 102 is formed of the fluoropolymer. In embodiments, the fluoropolymer can include one or more of ethylenetetrafluoroethylene (ETFE) polymer, polychlorotrifluoroethylene (PCTFE) polymer, polyvinyl fluoride (PVF) polymer, polyvinylidenc fluoride (PVDF) polymer, or the like. In an embodiment, the fluoropolymer is ETFE. The fitment body 102 can be made of a material selected to be capable of being welded to the material used for sheets to form the bag including fitment 100. In an embodiment, the fitment body 102 includes the same material as is used for the sheets forming the bag including fitment 100. Fitment body 102 includes a first side wall 104 and a second side wall 106. The first side wall 104 and second side wall 106 each extend from a first end point to a second end point. The first side wall 104 and the second side wall 106 can be shaped to define a central region of the fitment body 102 where one or more fittings including the spike port aperture 108 and optionally one or more additional ports 110 can be provided. The first side wall 104 and second side wall 106 can be configured to provide continuous surfaces to which sheets can be welded to form the bag including fitment 100. Examples of the extension, curvature, and geometry of the first side wall 104 and second side wall 106, as well as the welding of sheets to said first and second side walls 104 and 106 are further discussed in U.S. patent application Ser. No. 15/705,878, which is herein incorporated by reference in its entirety.

Spike port aperture 108 is an opening through fitment 100 configured to accept a spike. The spike port aperture 108 extends from a part of fitment 100 that is outside a bag formed using fitment 100 to a part of fitment 100 that is inside the bag formed using fitment 100. The spike port aperture 108 is sized to correspond to the spike or spikes selected for use with the bag formed using fitment 100, such that spike port aperture 108 has an internal size capable of accommodating the spike(s). For example, the spike port aperture 108 can have an internal diameter larger than the outer diameter of the largest spike selected for use with the bag formed using the fitment 100. In an embodiment, spike port aperture 108 is provided at a part of fitment body 102 that does not extend past the edges of first and second side walls 106 on an outside of the bag formed using fitment 100.

Additional ports 110 can optionally be included in fitment 100, for example for filling, draining, and or venting the bag formed using fitment 100, for example during processes such as vaccine manufacture. Hose barb connections 112 can be provided on projections through which optional additional ports 110 pass through. Hose barb connections 112 are provided on a side of first and second side walls 104, 106 such that the hose barb connections 112 are outside a bag formed including the fitment 100.

Guide projection 114 extends from fitment body 102 such that the guide projection 114 extends into the internal space of a bag formed using the fitment 100. Guide projection 114 is an example of a guide feature configured to prevent contact between a spike inserted into the bag through spike port aperture 108 and a sheet attached to fitment 100 to form a bag. The guide feature thus allows insertion of a spike without risk of piercing or otherwise damaging the bag formed using fitment 100. Spike port aperture 108 passes through guide projection 114. The guide projection 114 is configured to extend spike port aperture 108 such that the spike terminates within the spike port aperture 108, and the spike thus cannot contact sheets used to form a bag along with the fitment 100. In an embodiment, guide projection 114 has a generally conical or frustoconical shape. In an embodiment, guide projection 114 has a generally cylindrical shape. In an embodiment, an end of the guide projection 114 is radiused or otherwise smoothed to prevent damage to sheets of a bag formed using the fitment 100.

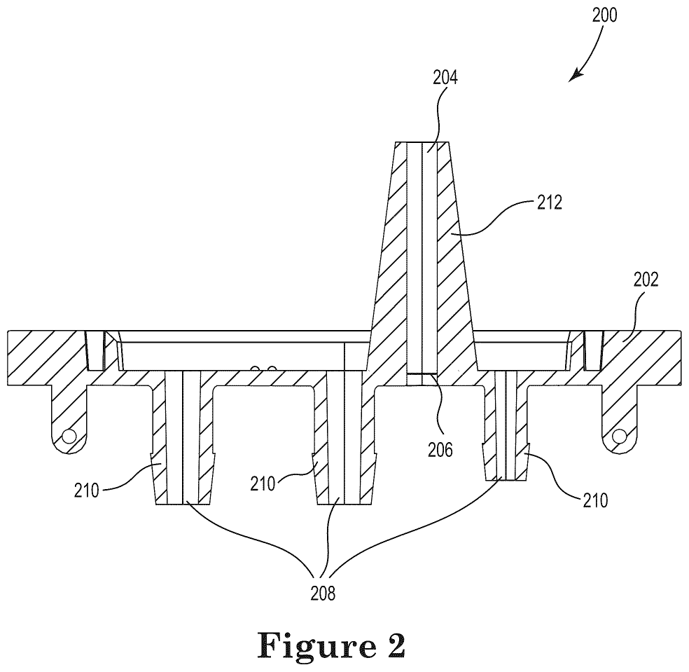

FIG. 2 shows a sectional view of a fitment according to an embodiment. Fitment 200 includes fitment body 202, spike port aperture 204, and barrier membrane 206. The fitment 200 can further include one or more additional ports 208 provided on hose barb connections 210. Fitment 200 further includes a guide projection 212. Fitment 200 further includes a barrier film 214.

Spike port aperture 204 is an opening formed through fitment body 202. A barrier membrane 206 is provided within spike port aperture, forming a puncture barrier and enclosing the bag formed by fitment 200 prior to penetration by the spike. Barrier membrane 206 can be formed integrally with fitment body 202. Barrier membrane 206 provides a puncture barrier within spike port aperture 204. Barrier membrane 206 can prevent flow out of the bag through spike port aperture 204 while intact. Barrier membrane 206 is configured to be punctured when the spike is inserted with sufficient force. In an embodiment, the puncture force for barrier membrane 206 can be 20 N or lower. In an embodiment, the puncture force for barrier membrane 206 is in a range from 5 N to 15 N. Barrier membrane 206 can be configured to provide a retention force for an inserted spike. The retention force can be any suitable retention force capable of retaining the spike to resist the action of gravity on the spike, resist incidental contact with the spike, bag, or the components attached to the spike. In an embodiment, barrier membrane 206 has a thickness in a range from 0.003 to 0.010 inches (7.6 to 25.4 μm). The barrier membrane thickness can be modified based on the material used for fitment body 202, the desired properties of puncture barrier 206 such as required puncture force, manufacturing constraints on the integral formation of barrier membrane 206, or the like.

Optional additional ports 208 can be provided in fitment body 202. The optional additional ports 208 can include one or more of fill, drain, venting, or any other suitable ports for accessing the contents of the bag. The optional additional ports 208 can be provided on projections extending from the fitment 200 such that the projections extend outside the bag when the bag is formed by attaching sheets to the fitment 200. The projections including optional additional ports 208 can further optionally include an interface feature, for example hose barbs 210 as shown in FIG. 2.

Guide projection 212 is an extension of fitment body 202 surrounding the spike port aperture 204. The guide projection 212 extends from the fitment body 202 such that guide projection 212 extends into the internal space of a bag formed by attaching sheets to the fitment 200. The guide projection 212 surrounds the spike port aperture 204. The guide projection 212 extends beyond an insertable length of a spike to be used with spike port aperture 204, such that an end of the spike remains within spike port aperture 204 along the length of guide projection 212 when the spike is fully inserted into the spike port aperture 204. The guide projection 212 thus allows the spike port aperture 204 to be provided on the fitment 200 without extending outwards from a bag, while preventing the spike from contacting and potentially damaging the sheets used to form a bag including the fitment 200.

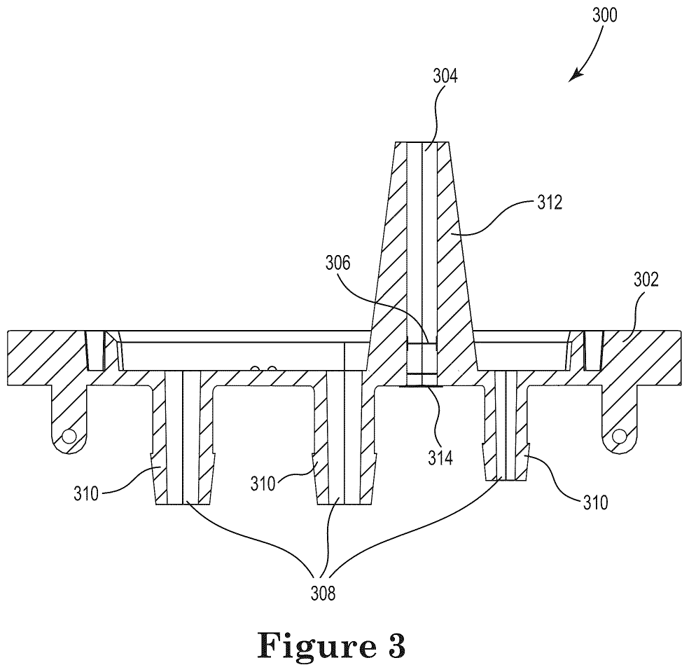

In an embodiment, fitment 200 can further include an optional barrier film provided over or in the spike port aperture 204, for example the barrier film 314 described below and shown in FIG. 3.

FIG. 3 shows a sectional view of a fitment according to an embodiment. Fitment 300 includes fitment body 302, spike port aperture 304, and internal gasket 306. The fitment can further include one or more additional ports 308 provided on hose barb connections 310. Fitment 300 further includes a guide projection 312.

Spike port aperture 304 is an opening formed through fitment body 302. Internal gasket 306 can be disposed within the spike port aperture 304. Internal gasket 306 is configured to provide a puncture barrier prior to insertion of a spike into aperture spike port aperture 304 and to retain said spike once it has been inserted into or through the internal gasket 306. The puncture barrier provided by internal gasket 306 can be in addition to another puncture barrier such as barrier film 214 described above and shown in FIG. 2. The internal gasket 306 can be a separate piece from the fitment body 302. The internal gasket 306 can be retained within spike port aperture 304 by any suitable connection, such as a mechanical connection, for example, a press-fit, engagement of one or more engagement features, contact with one or more shoulders formed within the spike port body 208, combinations thereof, and the like. In an embodiment, the puncture force for internal gasket 306 can be 20 N or lower. In an embodiment, the puncture force for internal gasket 306 is in a range from 5 N to 15 N. Internal gasket 306 can be formed of any one or more suitable materials, with non-limiting examples of suitable materials including silicone, ethyl vinyl acetate (EVA) polymers, thermoplastic elastomers, fluoropolymers, neoprene, and the like. The material of internal gasket 306 can have any suitable hardness. In an embodiment, the material of internal gasket 306 has a Shore A durometer of up to 90. In an embodiment, the material of internal gasket 306 has a Shore A durometer of from 50 to 90. In an embodiment, the material of internal gasket 306 has a Shore A durometer of from 50 to 70. In an embodiment, the material of internal gasket 306 has a Shore A durometer of approximately 70. The material of internal gasket 306 can have any suitable glass transition temperature selected on the conditions internal gasket 306 will be subjected to. In an embodiment, a glass transition temperature of the material of internal gasket 306 can be −30° C. or less. In an embodiment, a glass transition temperature of the material of internal gasket 306 can be −125° C. or less. In an embodiment, a glass transition temperature of the material of internal gasket 306 can be −170° C. or less.

Optional additional ports 308 can be provided in fitment body 302. The optional additional ports 308 can include one or more of fill, drain, sample, venting, or any other suitable ports for accessing the contents of the bag. The optional additional ports 308 can be provided on projections extending from the fitment 300 such that the projections extend outside the bag when the bag is formed by attaching sheets to the fitment 300. The projections including optional additional ports 308 can further optionally include an interface feature, for example hose barbs 310 as shown in FIG. 3.

Guide projection 312 is an extension of fitment body 302 surrounding the spike port aperture 304. The guide projection 312 extends from the fitment body 302 such that guide projection 312 extends into the internal space of a bag formed by attaching sheets to the fitment 300. The guide projection 312 surrounds the spike port aperture 304. The guide projection 312 extends beyond an insertable length of a spike to be used with spike port aperture 304, such that an end of the spike remains within spike port aperture 304 along the length of guide projection 312 when the spike is fully inserted into the spike port aperture 304. The guide projection 312 thus allows the spike port aperture 304 to be provided on the fitment 300 without extending outwards from a bag, while preventing the spike from contacting and potentially damaging the sheets used to form a bag including the fitment 300.

Optional barrier film 314 can be provided over the bag exterior side of the spike port aperture 304. Barrier film 314 provides a second puncture barrier in addition to the barrier membrane 306. In an embodiment, barrier film 314 is a film of a biocompatible material. In an embodiment, barrier film 314 is a film formed of the same material as one or both of fitment 300 and/or sheets used to form a bag using the fitment 300. Barrier film 314 can be attached to fitment body 302 by any suitable connection, such as a weld, an adhesive, or the like. In an embodiment, barrier film 314 is attached to the fitment body 302 by way of a weld, such as an ultrasonic weld. Barrier film 314 can be configured to have a puncture force similar to a puncture force of the internal gasket 306 or barrier membrane 206 as described above and shown in FIG. 2. In embodiments, barrier film 314 can have a puncture force of 20 N or less. Barrier film 314 can be configured to provide a retention force for an inserted spike. The retention force can be any suitable retention force capable of retaining the spike to resist the action of gravity on the spike, resist incidental contact with the spike, bag, or the components attached to the spike. In an embodiment, the retention force provided by the spike port aperture 204 or 304, barrier membrane 206 or internal gasket 306, and optionally further including barrier film 314 can be greater than the puncture force. In an embodiment, the retention force provided by the spike port aperture 204 or 304, barrier membrane 206 or internal gasket 306, and optionally further including barrier film 314 can be greater than 20 N.

FIG. 4 shows a bag according to an embodiment. Bag 400 includes fitment 402 and one or more sheets 404. The fitment 402 includes a spike port aperture (not shown) the fitment 402 further includes first side wall 406, a second side wall (not shown), one or more additional ports 408 provided on hose barb connections 410, and a guide projection 412.

Bag 400 is a bag configured to accommodate a material, such as a liquid. Non-limiting examples of the material that can be stored in the bag can include drug products, proteins, blood products, and/or buffer materials. Bag 400 can be configured such that it is sterilizable, for example by gamma irradiation. An example of such irradiation is discussed in U.S. patent application Ser. No. 15/705,878, which is herein incorporated by reference in its entirety. Bag 400 can further be configured for use at cryogenic temperatures, such as dry ice temperatures, liquid nitrogen temperatures, or the like. In an embodiment, the bag 400 can be exposed to a temperature of −50° C. or lower. In an embodiment, the bag 400 can be exposed to a temperature of −80° C. or lower. In an embodiment, the bag 400 can be exposed to a temperature of −150° C. or lower. In an embodiment, the bag 400 can be exposed to a temperature of −190° C. or lower.

Fitment 402 is a fitment to which sheets 404 can be attached to form bag 400. Fitment 402 can further provide a spike port aperture and one or more additional ports 408 to allow communication with the internal space of bag 400. The fitment 402 can be formed of any suitable biocompatible material, such as a fluoropolymer, a polyolefin, EVA, or the like. The fitment 402 can be made of a material selected to be capable of being welded to the material used for sheets to form the bag 400.

Sheets 404 are one or more polymer sheets that are sealed to fitment 402 and/or one another to define an internal space and form the bag 400. The sheets 404 can be formed of any suitable biocompatible material, such as a fluoropolymer, a polyolefin, EVA, or the like. In an embodiment, the sheets 404 are formed of a fluoropolymer film. In some embodiments, the fluoropolymer film includes an ethylenetetrafluoroethylene (ETFE) polymer, a polychlorotrifluoroethylene (PCTFE) polymer, a polyvinyl fluoride (PVF) polymer, a polyvinylidene fluoride (PVDF) polymer or a combination thereof. In another embodiment, the fluoropolymer film includes an ethylenetetrafluoroethylene (ETFE) polymer, a polyvinyl fluoride (PVF) polymer, a polyvinylidene fluoride (PVDF) polymer or a combination thereof. The sheets 404 can include materials selected for compatibility with the material of fitment 402, such that the sheets can be attached to fitment 402, for example by a weld such as an ultrasonic weld.

First side wall 406 and a second side wall are provided on the fitment, each extending from a first end point to a second end point. The second side wall can be, for example, second side wall 106 as discussed above. The first side wall 406 and the second side wall can be shaped to define a central region of the fitment 402 where one or more fittings including the spike port aperture and optionally one or more additional ports 408 can be provided. The first side wall 406 and second side wall can be configured to provide continuous surfaces to which sheets 404 can be attached to form bag 400. Examples of the extension, curvature, and geometry of the first side wall 406 and second side wall, as well as the welding of sheets such as sheets 404 to said first and second side walls are further discussed in U.S. patent application Ser. No. 15/705,878, which is herein incorporated by reference in its entirety.

Optionally, additional ports 408 can be provided in fitment 402. The optional additional ports 408 can include one or more of fill, drain, venting, or any other suitable ports for accessing the contents of the bag. The optional additional ports 408 can be provided on projections extending from the fitment 400 such that the projections extend outside the bag when the bag is formed by attaching sheets to the fitment 400. The projections including optional additional ports 408 can further optionally include an interface feature, for example hose barbs 410 as shown in FIG. 4.

Guide projection 412 is an extension of fitment 402 surrounding the spike port aperture. The guide projection 412 extends from the fitment 402 such that guide projection 412 extends into the internal space of bag 400. The guide projection 412 surrounds the spike port aperture. The guide projection 412 extends beyond an insertable length of a spike to be used with the spike port aperture, such that an end of the spike remains within the spike port aperture along the length of guide projection 412 when the spike is fully inserted. The guide projection 412 thus allows the spike port aperture to be provided on the fitment 400 without extending outwards from a bag, while preventing the spike from contacting and potentially damaging the sheets 404 used to form bag 400.

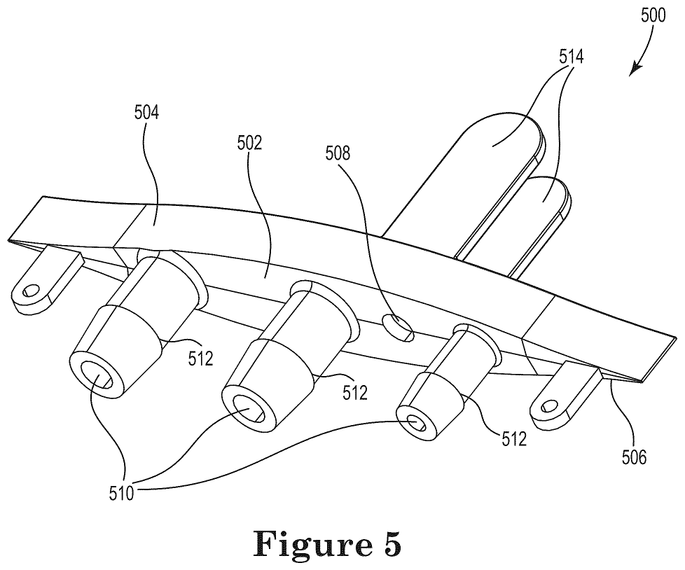

FIG. 5 shows a fitment according to an embodiment. Fitment 500 includes fitment body 502 having first side wall 504 and second side wall 506. Fitment body 502 further includes spike port aperture 508 and one or more additional ports 510 provided on hose barb connections 512. Fitment 500 further includes wings 514.

Fitment 500 is a fitment used for forming a bag. One or more sheets can be attached to fitment 500 to define the bag, with the sheets being sealed to the fitment 500 and scaled around a perimeter of the bag outside of the fitment 500, so as to define an internal space. A bag formed using a fitment such as fitment 500 is described below and shown in FIG. 4.

Fitment body 502 is a body configured to form a fitment for a bag. Fitment body 502 can be formed of any suitable biocompatible material, such as a fluoropolymer, a polyolefin, EVA, or the like. In an embodiment, the fitment body 502 is formed of the fluoropolymer. In embodiments, the fluoropolymer can include one or more of ethylenetetrafluoroethylene (ETFE) polymer, polychlorotrifluoroethylene (PCTFE) polymer, polyvinyl fluoride (PVF) polymer, polyvinylidene fluoride (PVDF) polymer, or the like. In an embodiment, the fluoropolymer is ETFE. The fitment body 502 can be made of a material selected to be capable of being welded to the material used for sheets to form the bag including fitment 500. In an embodiment, the fitment body 502 includes the same material as is used for the sheets forming the bag including fitment 500. Fitment body 502 includes a first side wall 504 and a second side wall 506. The first side wall 504 and second side wall 506 each extend from a first end point to a second end point. The first side wall 504 and the second side wall 506 can be shaped to define a central region of the fitment body 502 where one or more fittings including the spike port aperture 508 and optionally one or more additional ports 510 can be provided. The first side wall 504 and second side wall 506 can be configured to provide continuous surfaces to which sheets can be welded to form the bag including fitment 500. Examples of the extension, curvature, and geometry of the first side wall 504 and second side wall 506, as well as the welding of sheets to said first and second side walls 504 and 506 are further discussed in U.S. patent application Ser. No. 15/705,878, which is herein incorporated by reference in its entirety.

Spike port aperture 508 is an opening through fitment 500 configured to accept a spike. The spike port aperture 508 extends from a part of fitment 500 that is outside a bag formed using fitment 500 to a part of fitment 500 that is inside the bag formed using fitment 500. The spike port aperture 508 is sized to correspond to the spike or spikes selected for use with the bag formed using fitment 500, such that spike port aperture 508 has an internal size capable of accommodating the spike(s). For example, the spike port aperture 508 can have an internal diameter larger than the outer diameter of the largest spike selected for use with the bag formed using the fitment 500. In an embodiment, spike port aperture 508 is provided at a part of fitment body 502 that does not extend past the edges of first and second side walls 506 on an outside of the bag formed using fitment 500.

Additional ports 510 can optionally be included in fitment 500, for example for filling, draining, and or venting the bag formed using fitment 500, for example during processes such as vaccine manufacture. Hose barb connections 512 can be provided on projections through which optional additional ports 510 pass through. Hose barb connections 512 are provided on a side of first and second side walls 504, 506 such that the hose barb connections 512 are outside a bag formed including the fitment 500.

Wings 514 are provided as the guide feature included in fitment 500 to prevent contact between a spike and sheets of a bag formed using fitment 500. Wings 514 are projections from the fitment body 502 of fitment 500. In an embodiment, wings 514 extend from one or both of first and second side walls 504, 506 configured to extend into the internal space of a bag formed using the fitment 500. Wings 514 can be shaped and sized to prevent contact between a spike inserted into the spike port aperture 508 and sheets used to form the bag including fitment 500. Wings 514 can be configured to extend a length into the internal space that is greater than the potential extension of a spike into the internal space when fully inserted into spike port aperture 508. In the embodiment shown in FIG. 5, wings 514 are provided extending from each of first and second side walls 504, 506. In embodiments, one wing 514 can be provided to prevent contact between the spike and one of the sheets forming the bag including fitment 500. In such embodiments, the spike port aperture 508 can be positioned and/or angled such that the spike is less likely to contact an unprotected sheet of the bag. In an embodiment, the spike port aperture 508 can have one or more indexing features configured to ensure orientation of the spike. In embodiments, the wings 514 can include smoothing at potential points of contact with the sheets used with fitment 500 to form a bag, such as a bevel, radiusing, a chamfer or the like.

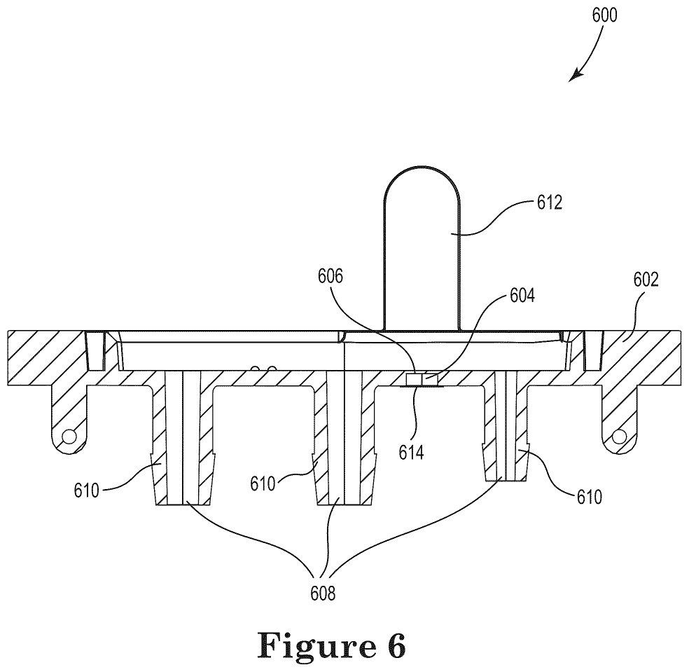

FIG. 6 shows a sectional view of a fitment according to an embodiment. Fitment 600 includes fitment body 602, spike port aperture 604, and barrier membrane 606. The fitment 600 can further include one or more additional ports 608 provided on hose barb connections 610. Fitment 600 further includes one or more wings 612. Fitment 600 further includes a barrier film 614.

Spike port aperture 604 is an opening formed through fitment body 602. A barrier membrane 606 is provided within spike port aperture, forming a puncture barrier and enclosing the bag formed by fitment 600 prior to penetration by the spike. Barrier membrane 606 can be formed integrally with fitment body 602. Barrier membrane 606 provides a puncture barrier within spike port aperture 604. Barrier membrane 606 can prevent flow out of the bag through spike port aperture 604 while intact. Barrier membrane 606 is configured to be punctured when the spike is inserted with sufficient force. In an embodiment, the puncture force for barrier membrane 206 can be 20 N or lower. In an embodiment, the puncture force for barrier membrane 206 can be in a range from 5 N to 15 N. In an embodiment, barrier membrane 606 has a thickness in a range from 0.003 to 0.010 inches (7.6 to 25.4 μm). The barrier membrane thickness can be modified based on the material used for fitment body 602, the desired properties of puncture barrier 606 such as required puncture force, manufacturing constraints on the integral formation of barrier membrane 606, or the like.

Optional additional ports 608 can be provided in fitment body 602. The optional additional ports 608 can include one or more of fill, drain, venting, or any other suitable ports for accessing the contents of the bag. The optional additional ports 608 can be provided on projections extending from the fitment 600 such that the projections extend outside the bag when the bag is formed by attaching sheets to the fitment 600. The projections including optional additional ports 608 can further optionally include an interface feature, for example hose barbs 610 as shown in FIG. 6.

Wings 612 are configured to extend into the internal space of a bag formed using the fitment 600. Wings 612 can be shaped and sized to prevent contact between a spike inserted into the spike port aperture 604 and sheets used to form the bag including fitment 600. Wings 612 can be configured to extend a length into the internal space that is greater than the potential extension of a spike into the internal space when fully inserted into spike port aperture 604.

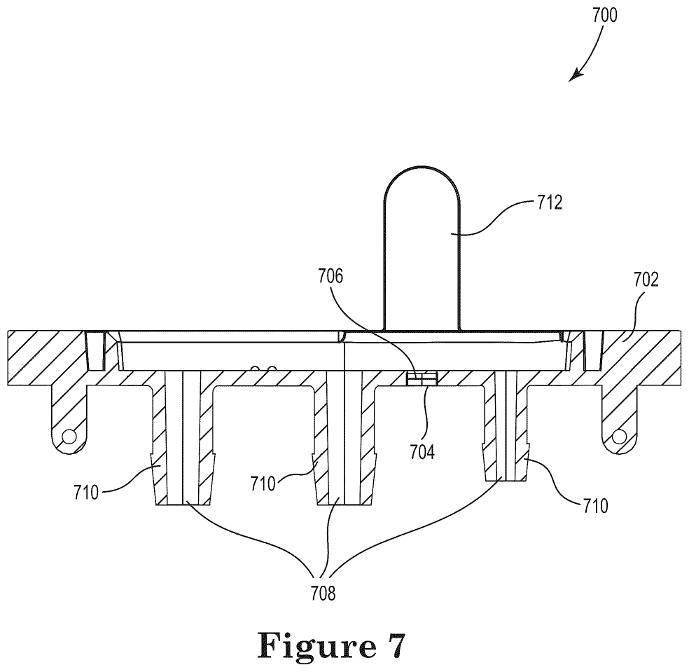

Optional barrier film 614 can be provided over the bag exterior side of the spike port aperture 604. Barrier film 614 provides a second puncture barrier in addition to the barrier membrane 606. In an embodiment, barrier film 614 is a film of a biocompatible material. In an embodiment, barrier film 614 is a film formed of the same material as one or both of fitment 600 and/or sheets used to form a bag using the fitment 600. Barrier film 614 can be attached to fitment body 602 by any suitable connection, such as a weld, an adhesive, or the like. In an embodiment, barrier film 614 is attached to the fitment body 602 by way of a weld, such as an ultrasonic weld. Barrier film 614 can be configured to have a puncture force similar to a puncture force of the barrier membrane 606 or internal gasket 706 as described above and shown in FIG. 7. In embodiments, barrier film 614 can have a puncture force of 20 N or less. Barrier film 614 can be configured to provide a retention force for an inserted spike. The retention force can be any suitable retention force capable of retaining the spike to resist the action of gravity on the spike, resist incidental contact with the spike, bag, or the components attached to the spike. In an embodiment, the retention force provided by the spike port aperture 604 or 704, barrier membrane 606 or internal gasket 706, and optionally further including barrier film 714 can be greater than the puncture force. In an embodiment, the retention force provided by the spike port aperture 604 or 704, barrier membrane 606 or internal gasket 706, and optionally further including barrier film 714 can be greater than the 20 N.

FIG. 7 shows a sectional view of a fitment according to an embodiment. Fitment 700 includes fitment body 702, spike port aperture 704, and internal gasket 706. The fitment can further include one or more additional ports 708 provided on hose barb connections 710. Fitment 700 further includes one or more wings 712.

Spike port aperture 704 is an opening formed through fitment body 702. Internal gasket 706 can be disposed within the spike port aperture 704. Internal gasket 706 is configured to provide a puncture barrier prior to insertion of a spike into aperture spike port aperture 704 and to retain said spike once it has been inserted into or through the internal gasket 706. The puncture barrier provided by internal gasket 706 can be in addition to another puncture barrier such as barrier film 614 described above and shown in FIG. 6. The internal gasket 706 can be a separate piece from the fitment body 702. The internal gasket 706 can be retained within spike port aperture 704 by any suitable connection, such as a mechanical connection, for example, a press-fit, engagement of one or more engagement features, contact with one or more shoulders formed within the spike port aperture 704, combinations thereof, and the like. In an embodiment, the puncture force for internal gasket 706 can be 20 N or lower. In an embodiment, the puncture force for internal gasket 706 is in a range from 5 N to 15 N. Internal gasket 706 can be formed of any one or more suitable materials, with non-limiting examples of suitable materials including silicone, ethyl vinyl acetate (EVA) polymers, thermoplastic elastomers, fluoropolymers, neoprene, and the like. The material of internal gasket 706 can have any suitable hardness. In an embodiment, the material of internal gasket 706 has a Shore A durometer of up to 90. In an embodiment, the material of internal gasket 706 has a Shore A durometer of from 50 to 90. In an embodiment, the material of internal gasket 706 has a Shore A durometer of from 50 to 70. In an embodiment, the material of internal gasket 706 has a Shore A durometer of approximately 70. The material of internal gasket 706 can have any suitable glass transition temperature selected on the conditions internal gasket 706 will be subjected to. In an embodiment, a glass transition temperature of the material of internal gasket 706 can be −70° C. or less. In an embodiment, a glass transition temperature of the material of internal gasket 706 can be −125° C. or less. In an embodiment, a glass transition temperature of the material of internal gasket 706 can be −170° C. or less.

Optional additional ports 708 can be provided in fitment body 702. The optional additional ports 708 can include one or more of fill, drain, venting, or any other suitable ports for accessing the contents of the bag. The optional additional ports 708 can be provided on projections extending from the fitment 700 such that the projections extend outside the bag when the bag is formed by attaching sheets to the fitment 700. The projections including optional additional ports 708 can further optionally include an interface feature, for example hose barbs 710 as shown in FIG. 7.

Wings 712 are configured to extend into the internal space of a bag formed using the fitment 700. Wings 712 can be shaped and sized to prevent contact between a spike inserted into the spike port aperture 704 and sheets used to form the bag including fitment 700. Wings 712 can be configured to extend a length into the internal space that is greater than the potential extension of a spike into the internal space when fully inserted into spike port aperture 704.

In an embodiment, fitment 700 can further include an optional barrier film provided over or in the spike port aperture 704, for example the barrier film 214 or barrier film 614 described above and shown in FIGS. 2 and 6, respectively.

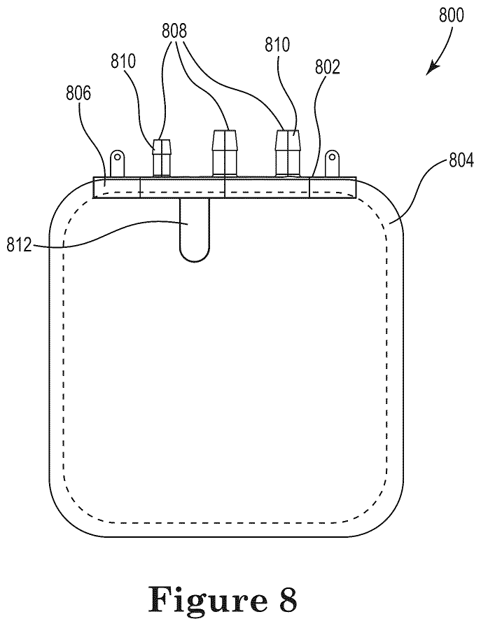

FIG. 8 shows a bag according to an embodiment. Bag 800 includes fitment 802 and one or more sheets 804. The fitment 802 includes a spike port aperture (not shown) the fitment 802 further includes first side wall 806, a second side wall (not shown), one or more additional ports 808 provided on hose barb connections 810, and one or more wings 812.

Bag 800 is a bag configured to accommodate a material, such as a liquid. Non-limiting examples of the material that can be stored in the bag can include drug products, proteins, blood products, and/or buffer materials. Bag 800 can be configured such that it is sterilizable, for example by gamma irradiation. An example of such irradiation is discussed in U.S. patent application Ser. No. 15/705,878, which is herein incorporated by reference in its entirety. Bag 800 can further be configured for use at cryogenic temperatures, such as dry ice temperatures, liquid nitrogen temperatures, or the like. In an embodiment, the bag 800 can be exposed to a temperature of −50° C. or lower. In an embodiment, the bag 800 can be exposed to a temperature of −80° C. or lower. In an embodiment, the bag 800 can be exposed to a temperature of −150° C. or lower. In an embodiment, the bag 800 can be exposed to a temperature of −190° C. or lower.

Fitment 802 is a fitment to which sheets 804 can be attached to form bag 800. Fitment 802 can further provide a spike port aperture and one or more additional ports 808 to allow communication with the internal space of bag 800. The fitment 802 can be formed of any suitable biocompatible material, such as a fluoropolymer, a polyolefin, EVA, or the like. The fitment 802 can be made of a material selected to be capable of being welded to the material used for sheets to form the bag 800.

Sheets 804 are one or more polymer sheets that are sealed to fitment 802 and/or one another to define an internal space and form the bag 800. The sheets 804 can be formed of any suitable biocompatible material, such as a fluoropolymer, a polyolefin, EVA, or the like. In an embodiment, the sheets 804 are formed of a fluoropolymer film. In some embodiments, the fluoropolymer film includes an ethylenetetrafluoroethylene (ETFE) polymer, a polychlorotrifluoroethylene (PCTFE) polymer, a polyvinyl fluoride (PVF) polymer, a polyvinylidene fluoride (PVDF) polymer or a combination thereof. In another embodiment, the fluoropolymer film includes an ethylenetetrafluoroethylene (ETFE) polymer, a polyvinyl fluoride (PVF) polymer, a polyvinylidene fluoride (PVDF) polymer or a combination thereof. The sheets 804 can include materials selected for compatibility with the material of fitment 802, such that the sheets can be attached to fitment 802, for example by a weld such as an ultrasonic weld.

First side wall 806 and a second side wall are provided on the fitment, each extending from a first end point to a second end point. The second side wall can be, for example, second side wall 106 as discussed above. The first side wall 806 and the second side wall can be shaped to define a central region of the fitment 802 where one or more fittings including the spike port aperture and optionally one or more additional ports 808 can be provided. The first side wall 806 and second side wall can be configured to provide continuous surfaces to which sheets 804 can be attached to form bag 800. Examples of the extension, curvature, and geometry of the first side wall 806 and second side wall, as well as the welding of sheets such as sheets 804 to said first and second side walls are further discussed in U.S. patent application Ser. No. 15/705,878, which is herein incorporated by reference in its entirety.

Optionally, additional ports 808 can be provided in fitment 802. The optional additional ports 808 can include one or more of fill, drain, sampling, venting, or any other suitable ports for accessing the contents of the bag. The optional additional ports 808 can be provided on projections extending from the fitment 800 such that the projections extend outside the bag when the bag is formed by attaching sheets to the fitment 800. The projections including optional additional ports 808 can further optionally include an interface feature, for example hose barbs 810 as shown in FIG. 8.

Wings 812 are provided as the guide feature included in fitment 502 to prevent contact between a spike and sheets 504 of when a spike is inserted into bag 500. Wings 812 are projections from one or both of first side wall 806 and the second side wall. Wings 812 configured to extend into the internal space of bag 800. Wings 812 can be shaped and sized to prevent contact between a spike inserted into the spike port aperture the sheets 804. Wings 812 can be configured to extend a length into the internal space of bag 800 that is greater than the potential extension of a spike into the internal space when said spike is fully inserted into spike port aperture.

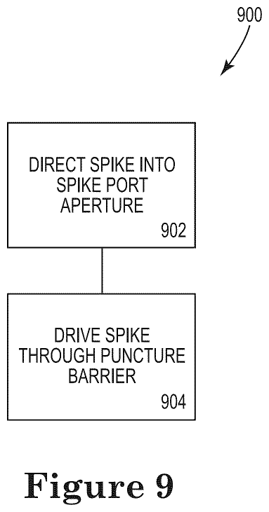

FIG. 9 is a flowchart of a method of interfacing with a bag. Method 900 includes directing a spike into a spike port aperture provided on a fitment of the bag at 902, and driving the spike through a puncture barrier disposed in the spike port aperture at 904.

A spike is directed into a spike port aperture of a fitment at 902. The spike port aperture can be, for example, any spike port aperture provided herein. The spike can be any suitable spike for interfacing with the bag, for example any suitable medical spike that the spike port aperture is sized to accommodate. In an embodiment, when the spike is directed into the spike port aperture at 902, the spike can penetrate a barrier film such as optional barrier films 214 or 614 described above and shown in FIGS. 2 and 6, respectively.

The spike is driven through a puncture barrier disposed in the spike port aperture at 904. The puncture barrier can be integral with the fitment, such as barrier membranes 206 or 606 as described above and shown in FIGS. 2 and 6, respectively, or separate from the fitment, such as internal gaskets 306 or 706 as described above and shown in FIGS. 3 and 7, respectively. The penetration of the puncture barrier by the spike can allow the spike to access the contents of the bag. In an embodiment, following driving the spike through the puncture barrier at 904, the spike can penetrate a barrier film such as optional barrier films 214 or 614 described above and shown in FIGS. 2 and 6, respectively.

After the spike is driven through the puncture barrier at 904, the spike can be separated from the sheets forming the bag by way of a guide projection such as guide projections 114, 212, 312, or 412 as described above and respectively shown in FIGS. 1-4, wings such as wings 514, 612, 712, or 812 as described above and respectively shown in FIGS. 5-8, or any other suitable guide features for preventing contact between the spike and sheets of the bag.

### Aspects:

It is understood that any of aspects 1-10 can be combined with any of aspects 11-15 or 16-20. It is understood that any of aspects 11-15 can be combined with any of aspects 16-20.

Aspect 1. A fitment for a bag, comprising:
a fitment body including first and second side walls, each of the first and second side walls extending between opposing end points, the fitment body comprising a biocompatible material, wherein
the fitment body includes a spike port aperture, and
the fitment body includes one or more guide features, the guide features configured to separate a spike inserted into the spike port aperture from a bag sheet attached to one or both of the first and second side walls.

Aspect 2. The fitment according to aspect 1, wherein the one or more guide features include a guide projection extending from the fitment body, wherein the spike port aperture extends through the guide projection.

Aspect 3. The fitment according to any of aspects 1-2, wherein the one or more guide features include a plurality of wings extending from the first and/or second side walls.

Aspect 4. The fitment according to any of aspects 1-3, further comprising a plurality of additional ports formed integrally in the fitment body.

Aspect 5. The fitment according to aspect 4, wherein the spike port aperture is located between two of the plurality of additional ports.

Aspect 6. The fitment according to any of aspects 1-5, wherein the spike port aperture includes a barrier membrane.

Aspect 7. The fitment according to aspect 6, wherein the barrier membrane is formed integrally with the fitment body.

Aspect 8. The fitment according to aspect 7, further comprising a barrier film located at an end of the spike port aperture.

Aspect 9. The fitment according to any of aspects 1-8, further comprising an internal gasket disposed in the spike port aperture.

Aspect 10. The fitment according to aspect 9, further comprising a barrier film located at an end of the spike port aperture.

Aspect 11. A bag, comprising:
a fitment including a fitment body including first and second side walls, each of the first and second side walls extending between opposing end points, the fitment body comprising a fluoropolymer material, wherein the fitment body includes a spike port aperture and one or more guide features; and
one or more polymer sheets, the one or more polymer sheets joined to the first and second side walls, the one or more polymer sheets sealed to form the bag,
wherein the one or more guide features extend into an internal space defined by the fitment and the one or more polymer sheets, the one or more guide features configured to separate a spike inserted into the spike port aperture from the one or more polymer sheets.

Aspect 12. The bag according to aspect 11, wherein the one or more guide features include a guide projection extending from the fitment body, wherein the spike port aperture extends through the guide projection.

Aspect 13. The bag according to any of aspects 11-12, wherein the one or more guide features include a plurality of wings extending from the first and/or second side walls.

Aspect 14. The bag according to any of aspects 11-13, wherein the spike port aperture includes a barrier membrane formed integrally with the fitment.

Aspect 15. The bag according to any of aspects 11-14, further comprising an internal gasket disposed in the spike port aperture.

Aspect 16. A method of inserting a spike into a bag, comprising directing the spike into a spike port aperture provided on a fitment included in the bag and driving the spike through a puncture barrier disposed in the spike port aperture, wherein one or more guide features are disposed between the spike and one or more sheets forming the bag once the spike has been inserted into the bag.

Aspect 17. The method according to aspect 16, wherein the one or more guide features include a guide projection extending from the fitment body, wherein the spike port aperture extends through the guide projection.

Aspect 18. The method according to any of aspects 16-17, wherein the one or more guide features include a plurality of wings extending from first and/or second side walls of the fitment.

Aspect 19. The method according to any of aspects 16-18, further comprising driving the spike through a second puncture barrier provided on the fitment.

Aspect 20. The method according to aspect 19, wherein the spike is driven through the second puncture barrier as the spike enters the spike port aperture.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fitment for a bag, comprising:
a fitment body including first and second side walls, each of the first and second side walls extending between opposing end points, the fitment body comprising a biocompatible material, wherein
the fitment body includes a spike port aperture, and
the fitment body includes one or more guide features, the guide features configured to separate a spike inserted into the spike port aperture from a bag sheet attached to one or both of the first and second side walls.

2. The fitment of claim 1, wherein the one or more guide features include a guide projection extending from the fitment body, wherein the spike port aperture extends through the guide projection.

3. The fitment of claim 1, wherein the one or more guide features include a plurality of wings extending from the first and/or second side walls.

4. The fitment of claim 1, further comprising a plurality of additional ports formed integrally in the fitment body.

5. The fitment of claim 4, wherein the spike port aperture is located between two of the plurality of additional ports.

6. The fitment of claim 1, wherein the spike port aperture includes a barrier membrane.

7. The fitment of claim 6, wherein the barrier membrane is formed integrally with the fitment body.

8. The fitment of claim 7, further comprising a barrier film located at an end of the spike port aperture.

9. The fitment of claim 1, further comprising an internal gasket disposed in the spike port aperture.

10. The fitment of claim 9, further comprising a barrier film located at an end of the spike port aperture.

11. A bag, comprising:
a fitment including a fitment body including first and second side walls, each of the first and second side walls extending between opposing end points, the fitment body comprising a fluoropolymer material, wherein the fitment body includes a spike port aperture and one or more guide features; and
one or more polymer sheets, the one or more polymer sheets joined to the first and second side walls, the one or more polymer sheets sealed to form the bag,
wherein the one or more guide features extend into an internal space defined by the fitment and the one or more polymer sheets, the one or more guide features configured to separate a spike inserted into the spike port aperture from the one or more polymer sheets.

12. The bag of claim 11, wherein the one or more guide features include a guide projection extending from the fitment body, wherein the spike port aperture extends through the guide projection.

13. The bag of claim 11, wherein the one or more guide features include a plurality of wings extending from the first and/or second side walls.

14. The bag of claim 11, wherein the spike port aperture includes a barrier membrane formed integrally with the fitment.

15. The bag of claim 11, further comprising an internal gasket disposed in the spike port aperture.

16. A method of inserting a spike into a bag, comprising directing the spike into a spike port aperture provided on a fitment included in the bag and driving the spike through a puncture barrier disposed in the spike port aperture, wherein one or more guide features are disposed between the spike and one or more sheets forming the bag once the spike has been inserted into the bag.

17. The method of claim 16, wherein the one or more guide features include a guide projection extending from the fitment body, wherein the spike port aperture extends through the guide projection.

18. The method of claim 16, wherein the one or more guide features include a plurality of wings extending from first and/or second side walls of the fitment.

19. The method of claim 16, further comprising driving the spike through a second puncture barrier provided on the fitment.

20. The method of claim 19, wherein the spike is driven through the second puncture barrier as the spike enters the spike port aperture.
